(19) United States
(12) Patent Application Publication
(10) Pub. No.: US 2011/0311645 A1
(43) Pub. Date: Dec. 22, 2011

(54) MICROBIOLOGICAL CONTROL IN OIL AND GAS OPERATIONS

(76) Inventor: Raúl O. Diaz, Spring, TX (US)

(21) Appl. No.: 12/816,876

(22) Filed: Jun. 16, 2010

(51) Int. Cl. A01N 59/00; A01N 37/02; A01P 1/00; C09K 8/68

(52) U.S. Cl. 424/616; 507/211; 507/225; 507/209; 514/557

(57) ABSTRACT

A fracturing fluid may include water; at least one polymeric viscosifier; at least one proppant; and a solution of peracetic acid in an amount effective to inhibit bacterial growth. Other embodiments are directed to methods for inhibiting bacterial contamination in a fracturing fluid and/or ballast water.

### BACKGROUND OF INVENTION

1. Field of the Invention

Embodiments disclosed herein relate generally to use of biocides in oil and gas operations. In particular, embodiments disclosed herein relate generally to the use of biocides for microbiological control in ballast tanks of offshore drilling rigs and/or in fracturing fluids.

2. Background Art

The proliferation of microorganisms and the resultant formation of slime or biofilm is a problem, which commonly occurs in aqueous systems, including oil and gas operations. Problematic microbes may include bacteria, fungi, and algae. Due to the frequent use of sea water in oil and gas operations, however, various types of microorganisms such as plankton and bacteria and aquatic organisms such as minute shells may also be present in the water.

While many oil and gas operations use water, water stored in the ballast tanks of offshore rigs as well as the water used as the base fluid of fracturing fluids may be particularly degraded by microorganism growth. For example, in offshore rigs such as submersible and semi-submersible rigs, water is stored in ballast tanks (also referred to as buoyancy chambers or pontoons) to provide positioning and stability to the rig. However, the water stored within the ballast tanks may contain a broad spectrum of organisms and sediments, and during such storage, the microorganisms may proliferate and biofilm may develop, harboring very large populations of great microbial complexity. Eventually, the ballast tanks must be discharged prior to movement of the rig. Discharge of the ballast tanks may thus result in concerns as to whether a deleterious effect is had on the surrounding ecosystem.

Specifically, because the ballast water is held for a long period of time in a closed light-shielded condition, the amount of dissolved oxygen within the water is reduced. By discharging such ballast water as having a poor oxygen (reducing) condition, a concern may be raised on the effect of such discharge to organisms in the surrounding ocean area. Further, because the ballast water is held for a long period of time in a dark reducing condition, plankton or aerobic bacteria which require light or dissolved oxygen have low viability in the ballast water while cysts (in which plankton is in a dormant state) and anaerobic bacteria tend to grow.

Other than ballast tanks of rigs, microorganism growth also presents a problem in fracturing fluids. Specifically, fracturing fluids generally contain natural and/or synthetic polymers, which are exposed to an environment that is conducive to the growth of microorganisms. Some of the most favorable environments for bacteria are dirty frac tanks and mixing water. Microorganisms, for example bacteria, feed on polymers (e.g., gel stabilizers used in aqueous fracturing fluid processes) by releasing enzymes, which degrade the polymers to sugar. Microorganisms absorb these sugars through their cell walls, promoting further microorganism growth and polymer degradation. The growth of microorganisms (and degradation of the polymers) in these fluids can thus materially alter the physical characteristics of the fluids, particularly in loss of fluid viscosity and rendering the fluids ineffective for their intended purpose. Fluid degradation may also lead to the formation of a large biomass, which may plug the formation and reduce formation permeability and eventual production capabilities.

A wide variety of biocides have been used in various industries (other than oil and gas operations) to control microorganism growth. Oil and gas operations, unlike other industries, present unique challenges as compared to other industries. Specifically, the water in offshore rig ballast tanks and/or fracturing fluids are released into the environment, and many known biocides are harmful to the environment due to toxic by-products or are corrosive to metal that can cause failure of the equipment in which the water is stored. For example, hypochlorite, a known biocide, forms dangerous organochlorine compounds and is also corrosive to the ballast tanks of the rigs.

Accordingly, there exists a continuing need for the development of biocidal compositions that provide efficacy for controlling the growth of microorganisms in water used in oil and gas operations and that is also environmentally friendly.

### SUMMARY OF INVENTION

In one aspect, embodiments disclosed herein relate to a fracturing fluid that includes water; at least one polymeric viscosifier; at least one proppant; and a solution of peracetic acid in an amount effective to inhibit bacterial growth.

In another aspect, embodiments disclosed herein relate to a method for inhibiting bacterial contamination in a fracturing fluid that includes adding an effective bacterial inhibiting amount of peracetic acid into a fracturing fluid comprising water, at least one polymeric viscosifier, and at least one proppant.

In yet another aspect, embodiments disclosed herein relate to a method for inhibiting bacterial contamination in ballast water that includes injecting water into a ballast tank of an offshore oil rig; and adding an effective bacterial inhibiting amount of peracetic acid into the water.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF DRAWINGS

FIG. 1 is a floating semi-submersible drilling rig.

### DETAILED DESCRIPTION

In one aspect, embodiments disclosed herein relate to use of biocides in oil and gas operations. In particular, embodiments disclosed herein relate to the use of biocides for microbiological control in ballast tanks of offshore drilling rigs and/or in fracturing fluids.

The biocidal treatments of the present disclosure rely on the use of peracetic acid (sometimes referred to as peroxyacetic acid) therein to prevent the growth of and/or kill microorganisms present in oilfield water, such as ballast water in offshore drilling rigs and/or fracturing fluids. Peracetic acid, shown in formula (1) below, may be classified as a peroxide:

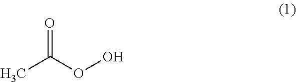

Generally, “peroxide” refers to any organic and inorganic compounds whose structures include the peroxy group, —O—O—. Their use as a biocide results from the instability of the peroxy bond. The characteristic properties of peroxide compounds are the liberation of oxygen as a result of thermal decomposition and the decomposition into oxygen and water. Thus, peracetic acid first decomposes into acetic acid and hydrogen peroxide, prior to the decomposition of hydrogen peroxide into oxygen and water, as shown in reaction pathway (2):

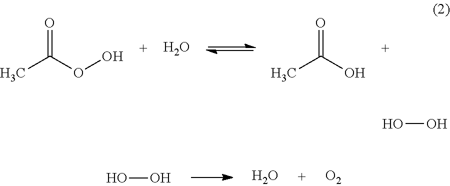

Peracetic acid may kill and prevent further growth of microorganisms by oxidation and subsequent disruption of their cell membrane, via the hydroxyl radical (HO.) that forms from the degradation of hydrogen peroxide. Further, because the by-products of peracetic acid are acetic acid and hydrogen peroxide (which subsequently results in water and oxygen), peracetic acid is non-toxic to the environment during the subsequent (and eventual) release of the treated water into the environment. Further, because peracetic acid is formed by the equilibrium reaction between acetic acid and hydrogen peroxide, peracetic acid may be supplied in solution with acetic acid and hydrogen peroxide (provided either as excess in the formation of peracetic acid or added to provide stabilization of the peracetic acid). Upon addition of the supplied peracetic acid to larger quantities of water, the equilibrium shifts to decompose peracetic acid into the acetic acid and hydrogen peroxide. Then, hydrogen peroxide then may decompose (by formation of two hydroxyl radicals) into water and oxygen.

In particular embodiments, peracetic acid may be present in the biocide solution in an amount ranging from about 1 to about 30 percent by weight (more preferable from about 5 to about 25 percent by weight or about 10 to about 20 percent by weight), hydrogen peroxide ranging in an amount up to about 30 percent by weight (preferably about 10 to about 20 percent by weight) of the biocide solution, and acetic acid ranging in an amount up to about 30 percent by weight (preferably about 5 to about 25 percent by weight) of the biocide solution, with the balance water. In other embodiments, more or less of the peracetic acid, hydrogen peroxide, and/or acetic acid may be included in the solution, depending on the desired concentration, level of bacterial growth, etc. Further, it is also within the scope of the present disclosure that other stabilizers (such as phosphonic acids, salts thereof, dipicolinic acid, salts thereof, or any mixture thereof, including 1-hydroxyethylidene-1,1-diphosphonic acid, 1-aminoethane-1,1-diphosphonic acid, aminotri-(methylene phosphonic acid), ethylenediamine-tetra(methylene phosphonic acid), hexamethylenediamine-tetra(methylene phosphonic acid), diethylenetriamine-penta(methylene phosphonic acid), diethylenetriamine-hexa(methylene phosphonic acid), dimethylamino methanediphosphonic acid, aminoacetic acid-N,N-dimethylene phosphonic acid, 3-aminopropane-1-hydroxy-1,1-diphosphonic acid, 2-phosphonobutane-1,2,4-tricarboxylic acid, phosphonosuccinic acid, 1-phosphono-1-methylsuccinic acid and 1-amino-phenylmethane diphosphonic acid) may be incorporated and that hydrogen peroxide and acetic acid may be present in the solution either as an excess from the formation of the peracetic acid or additional quantities of hydrogen peroxide and/or acetic acid may be added to the solution after the formation of the peracetic acid.

As mentioned above, in accordance with embodiments of the present disclosure, peracetic acid may be used as a biocidal treatment for ballast tanks of offshore oil rigs and/or fracturing fluids.

There are two basic types of offshore oil rigs: those that are permanently placed, such as fixed platforms, and those that can be moved from place to place, allowing for drilling in multiple locations. Such types of offshore oil rigs include fixed platform, jack-up platforms, Spar platforms, semi-submersible rigs, submersible rigs, production platforms, etc. Between these various rig types, some types of the movable drilling rigs include ballast tanks (or buoyancy chambers) near the bottom of their hulls, which when filled (generally with sea water) provides weight to keep them upright and in position (including sinking the rig into position and/or raising it) or compensate for sea conditions. Production platforms similarly have ballast tanks, into which water is introduced after building the platform so the platforms can be moved to their final location. Water is introduced into the ballast tanks to achieve the desired depth during the transit to the final site.

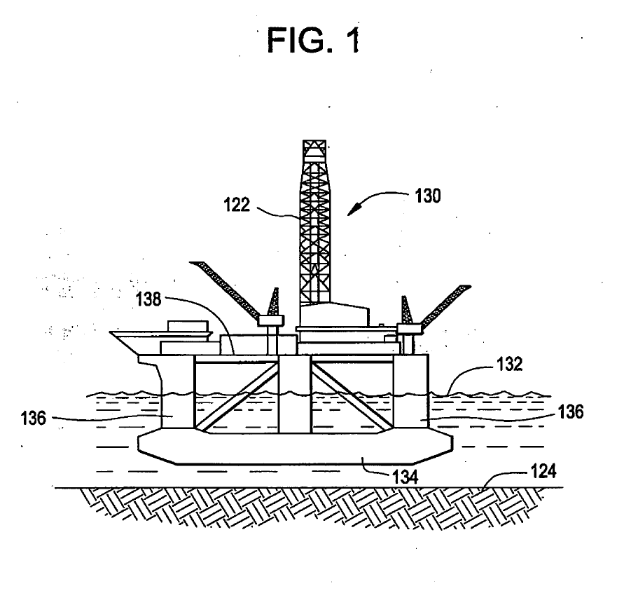

Referring to FIG. 1, a typical floating semi-submersible drilling rig is shown. As shown in FIG. 1, semi-submersible rig 130 is shown in drilling mode. On the platform or upper hull 138, a drilling rig assembly or derrick 122 is disposed, which supports a drilling assembly (not shown) that extends to the seabed 124. Large stability columns or struts 136 extend down from the upper hull 138 to the lower hull 134. While stability columns 136 support the upper hull (and deck) above the surface of the water 132, the lower hull 134 floats below the surface of the water 132. Ballast tanks (not shown separately) are formed within lower hull 134 and/or stability columns 136. As mentioned above, water may be stored within these ballast tanks to stabilize the rig. When the rig needs to be moved, the ballast tanks are emptied of water to raise the rig out of the water so that almost the whole rig can be seen. It is this ballast water that may be treated with the biocidal treatments of the present disclosure when taken into the ballast tanks. Specifically, because the ballast water is emptied into the environment (open sea), there exists environmental concerns on the types of biocidal treatments that can be used. However, because the biocide of the present disclosure, peracetic acid, decomposes into acetic acid, water, and oxygen, the treatment may be considered non-toxic and environmentally friendly upon degradation of the starting components. Depending on the length of water storage in the ballast tanks, and the potential effect of the produced oxygen on the metallic ballast, it may be desirable to use an oxygen scavenger and/or corrosion inhibitor in conjunction with the biocide treatment. Alternatively, the interior surface of the ballast tank may be treated with a corrosion resistant coating and/or an oxygen scavenger may be incorporated with the biocide to minimize any attacks of oxygen on the metallic surfaces of the ballast tank.

In another embodiment, the biocide of the present disclosure may be incorporated into fracturing fluids used in well stimulation. After a wellbore is drilled, the well may often be subjected to stimulation treatments to maximize the production of hydrocarbons therefrom. One such well stimulation treatment includes pumping fluids at high pressure and rate into the well such that the pressure exceeds the rock strength of the formation to create a fracture that may extend several hundred feet. This fracture creates a pathway through which hydrocarbons may flow into the well and to the surface. Such fluids are generally referred to as fracturing fluids and at least contain water and a polymeric viscosfier, and often also contain a proppant. Other additives frequently used in fracturing fluids include viscoelastic surfactant gels, gelled oils, crosslinkers and oxygen scavengers. Commonly used polymeric viscosifiers include polysaccharide and/or synthetic polymers such as polyacrylamides, polyglycosans, carboxyalkyl ethers, etc. Such polymeric viscosifiers may be used in any combination in fracturing fluids. The purpose of the polymeric viscosifier is to increase the viscosity of the fracturing fluid in order to assist in the creation of a fracture and/or to allow for the suspension of solid proppants that may also aid in creation and maintenance of the fracture. However, these polymeric viscosifiers are suspect to degradation by bacterial feeding on the polymers. When the bacteria ingest these polymers, they release enzymes which break down the polymer structures and block crosslinker sites, which in turn make the fracturing fluid less capable of adequate proppant transport. Once bacteria are pumped downhole, they may create hydrogen sulfide which corrodes subsurface equipment and/or plugs off an entire producing interval.

Thus, by incorporating peracetic acid into a fracturing fluid, the fracturing fluid may be rid of microorganisms, while avoiding the formation of toxic by-products. Rather, a fracturing fluid containing water, a polymeric viscosifier, proppants, and peracetic acid may be injected directly into the wellbore and into the formation at pressures effective to fracture the formation, whereby the peracetic acid decomposes into acetic acid and hydrogen peroxide (and subsequently water and oxygen) and simultaneously kills microorganisms present in the fracturing fluid.

Oxygen scavengers are reducing agents in that they remove dissolved oxygen from water by reducing molecular oxygen to compounds in which oxygen appears in the lower (i.e., −2) oxidation state. The reduced oxygen then combines with an acceptor atom, molecule or ion to form an oxygen-containing compound. To be suitable as an oxygen scavenger, the reducing agent must have an exothermic heat of reaction with oxygen and have reasonable reactivity at lower temperatures. Examples of known oxygen scavengers include hydrazine, ascorbic acid, hydroquinone, bisulfite salts, sodium hydrosulfite, etc. In a particular embodiment, to reduce or minimize any potential interference between the biocide and the oxygen scavenger (depending on the selected chemistry), the oxygen scavenger may be introduced upstream of the biocide so that the oxygen scavenging reaction may occur upstream (and faster) than the biocide, to result in minimal (if any) effect on the biocide reaction.

The amount of peracetic acid used in the biocidal treatments of the present disclosure may vary, generally depending on the conditions of the water, the polymers used in fracturing fluids, the extent of prior bacterial growth, the time period of bacterial growth, general environment where the biocide will be used, the extent of control desired, and the like. However, one skilled in the art will be able to determine the desired minimum amount needed to treat the target system with routine experimentation. Further, there is no maximum amount of biocide, although large excess may not be desirable for economic reasons. In a particular embodiment, the biocide solution may be introduced into the water (ballast water or fracturing fluid) in amounts that may be up to about 1 weight percent of the treated fluid, and in particular embodiments, the peracetic acid active may be used at amounts ranging from about 10 ppm to about 500 ppm, or about 25 ppm to about 250 ppm in yet other embodiments. Further, the treatment time period may be, for example, about 10 to 20 min, but may be longer or shorter depending on the amount of treatment needed.

Among the types of microorganisms controlled by the biocide treatments of the present disclosure, such organisms include viable and potentially invasive aquatic species such as, for example, plankton, phytoplankton, zooplankton, microbial organisms, nekton organisms, benthic organisms, etc. Phytoplankton (e.g. predominantly drifting plant life forms) includes the photosynthetic species such as the prevailing groups of algae, diatoms, and dinoflagellates, as well as their cyst and spore stages. Zooplankton includes drifting animal species that include everything from copepods, jellyfish, and shrimp to a broad range of macrovertebrate and macroinvertebrate egg and larval stages. Even more numerous is the broad range of microbial forms, including pathogenic bacteria that are of great public health concern. The nekton or free-swimming organisms, dominated by the fishes, may also be present in the water, in addition to benthic organisms living on the bottom (e.g., epifauna and epiflora) or within the surface of seabed sediments (e.g., infauna such as crabs, shellfish, and worms).

Embodiments of the present disclosure may provide at least one of the following advantages. The biocidal treatments of the present disclosure may provide efficacy for controlling the growth of microorganisms in water used in oil and gas operations. Further, whereas most biocides cannot be (or are not) used in oil and gas operations because they are not environmentally friendly (the water in offshore rig ballast tanks and/or fracturing fluids to be treated are released into the environment), the biocidal treatments of the present disclosure result in environmentally friendly by-products that may have minimal or no effect on the environment.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Furthermore, the invention encompasses any and all possible combination of some or all of the various embodiments described herein. Any and all patents, patent applications, scientific papers, and other references cited in this application, as well as any references cited therein, are hereby incorporated by reference in their entirety. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims

What is claimed:

1. A fracturing fluid, comprising:
water;
at least one polymeric viscosifier;
at least one proppant; and
a solution of peracetic acid in an amount effective to inhibit bacterial growth.

2. The fracturing fluid of claim 1, wherein the at least one polymeric viscosifier comprises at least one polymer selected from polysaccharides, polyacrylamides, polyglycosans, and carboxyalkyl ethers.

3. The fracturing fluid of claim 1, wherein the solution of peracetic acid further comprises water, acetic acid, and hydrogen peroxide.

4. The fracturing fluid of claim 1, further comprising at least one oxygen scavenger.

5. The fracturing fluid of claim 1, wherein the peracetic acid inhibits growth of at least one of plankton, phytoplankton, zooplankton, microbial organisms, nekton organisms, or benthic organisms in the fracturing fluid.

6. A method for inhibiting bacterial contamination in a fracturing fluid, comprising:
adding an effective bacterial inhibiting amount of peracetic acid into a fracturing fluid comprising water, at least one polymeric viscosifier, and at least one proppant.

7. The method of claim 6, further comprising:
injecting the fracturing fluid into a wellbore through a formation at sufficiently high pressures to fracture the formation.

8. The method of claim 6, wherein the at least one polymeric viscosifier comprises at least one polymer selected from the group consisting of: polysaccharides, polyacrylamides, polyglycosans, and carboxyalkyl ethers, and any combination thereof.

9. The method of claim 6, wherein the solution of peracetic acid further comprises water, acetic acid, and hydrogen peroxide.

10. The method of claim 6, wherein the fracturing fluid further comprises at least one oxygen scavenger.

11. The method of claim 6, wherein the peracetic acid inhibits growth of at least one of plankton, phytoplankton, zooplankton, microbial organisms, nekton organisms, or benthic organisms in the fracturing fluid

12. The method of claim 10, wherein the oxygen scavenger is injected into the fracturing fluid upstream of the peracetic acid.

13. A method for inhibiting bacterial contamination in ballast water, comprising:
injecting water into a ballast tank of an offshore oil rig; and
adding an effective bacterial inhibiting amount of peracetic acid into the water.

14. The method of claim 13, wherein the solution of peracetic acid further comprises water, acetic acid, and hydrogen peroxide.

15. The method of claim 13, wherein the offshore oil rig comprises a submersible rig, a semi-submersible rig, or a production platform.

16. The method of claim 13, further comprising:
discharging the water from the ballast into an open sea.

17. The method of claim 13, wherein an inner wall of the ballast tank comprises a corrosion-resistant coating disposed thereon.

18. The method of claim 13, further comprising:
adding at least one oxygen scavenger to the water.

19. The method of claim 13, wherein the peracetic acid inhibits growth of at least one of plankton, phytoplankton, zooplankton, microbial organisms, nekton organisms, or benthic organisms in the fracturing fluid

20. The method of claim 18, wherein the oxygen scavenger is injected into the ballast tank upstream of the peracetic acid.
